(19) United States
(12) Patent Application Publication
(10) Pub. No.: US 2005/0048093 A1
(43) Pub. Date: Mar. 3, 2005

(54) Methods and reagents for the control of infestations of parasites

(76) Inventors: Norberto Milani, Udine (IT); Georgio D. Vedova, Citizenship (IT); Francesco Nazzi, Cobroipo (IT)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/496,283

(22) PCT Filed: Nov. 25, 2002
(86) PCT No.: PCT/IB02/05447

(30) Foreign Application Priority Data
Nov. 23, 2001 (IT) UD2001A000193

(51) Int. Cl. A01N 27/00; A01N 25/00

(52) U.S. Cl. 424/405; 514/762

(57) ABSTRACT

The present invention relates to compositions for the modulation of acarid infestation of a colony of bees, said comprising alkenes selected from the group consisting of cis-6-heptadecene, cis-7-heptadecene, cis-8-heptadecene, cis-9-heptadecene, cis-6-pentadecene, cis 7-pentadecene, cis-8-pentadecene and cia-9-pentadecene, in particular comprising cis-8-heptadecene. The invention further relates to use of cis-8-heptadecene as an acaricide, and to methods of modulating mite infestation.

### FIELD OF THE INVENTION

The invention relates to a chemical composition for the control of infestations by parasites, methods of application of said composition and methods for the control of infestations by parasites, in particular the Varroa destructor mite in bee colonies. The composition contains at least one alkene with a number of carbon atoms less than 23, in particular a C15-C17 alkene, preferably with the double bond in the 6-8 position.

### BACKGROUND TO THE INVENTION

It is a well-known fact that the Varroa destructor mite causes very severe damage to honeybee colonies. This damage includes reduced production of honey, reduced strength of the bee colonies (also referred to as “family strength”) or even the destruction of the colonies themselves.

Numerous acaricides are available for combatting this mite, and these include fluvalinate, flumethrin, acrinathrin, amitraz, coumaphos and other related molecules. These acaricides have the disadvantage, however, that they do not have a specific action, and they can be toxic to bees to a greater or lesser degree, and they have lost efficacy in many geographic areas, as many populations of Varroa destructor have developed resistence to one or more acaricides and are therefore able to continue to reproduce on bee populations.

In order to obviate this problem, it is frequently necessary to increase the doses of these active compounds, with the resulting risk that unwanted residues will be left in the products generated by the bees, such as honey and wax. The accumulation of residues in the wax is of concern as this substance is used as a component of pharmaceutical and cosmetic creams and ointments and may not therefore present any residues of acaricides or other unwanted active compounds.

In order to resolve these well-known issues and to obtain further advantages, the applicant has researched and developed the following invention.

The invention seeks to overcome problem(s) associated with the prior art.

### SUMMARY OF THE INVENTION

The invention is based on the surprising finding that certain naturally occurring alarm or injury pheromones are effective in the prevention and/or treatment of mite infestations. Accordingly, the invention provides novel uses of certain compounds in the modulation of mite infestation and in the manufacture of medicaments and compositions for modulation of mite infestation, and further provides methods of modulating mite infestation.

This invention provides a chemical composition for the control of infestations of parasites, such as for example the Varroa destructor mite and other related species of the family Varroidae. The chemical composition is designed to be used for preference in colonies of hymenoptera of the genus Apis, and in particular Apis mellifera, the honey bee cultivated on all continents. The invention also covers a method of application of the chemical composition in infested locations such as colonies such as beehives and artificial cells where bees may be kept.

In one aspect the invention provides a composition for the modulation of acarid infestation of a colony of bees, characterised in that the composition comprises
(i) at least one alkene with an odd number of carbon atoms from 15 to 23, said alkene being in cis configuration and said alkene being selected from the group consisting of cis-6-heptadecene, cis-7-heptadecene, cis-8-heptadecene, cis-9-heptadecene, cis-6-pentadecene, cis-7-pentadecene, cis-8-pentadecene and cis-9-pentadecene; and
(ii) at least one excipient, diluent or carrier.

In another aspect, the invention relates to a composition as described above, characterised in that said alkene is a heptadecene with a double bond in position 8 in cis configuration (cis-8-heptadecene).

In another aspect, the invention relates to a composition as described above, characterised in that said alkene is a diene, with at least one double bond in position 9.

In another aspect, the invention relates to a composition as described above, characterised in that it further comprises one or more solvent(s).

In another aspect, the invention relates to a composition as described above, characterised in that it further comprises one or more anti-oxidants.

In another aspect, the invention relates to a use of composition as described above as an acaricide. In another aspect, the invention relates to a use as described above wherein said acarids belong to the family Varroidae. In another aspect, the invention relates to a use as described above wherein said acarids comprise Varroa destructor.

In another aspect, the invention relates to a use as described above characterised in that the alkene or composition is administered by way of a distribution system comprising a wax, polymer or hydrocarbon-type panel which is impregnated with said alkene or composition, or a distribution system comprising a spray device, or a distribution system comprising sugar-based feed for bees.

In another aspect, the invention relates to a use as described above characterised in that the distribution system initially contains a quantity of alkene of between 10 μg and 10 mg.

In another aspect, the invention relates to a use of an alkene selected from the group consisting of cis-6-heptadecene, cis-7-heptadecene, cis-8-heptadecene, cis-9-heptadecene, cis-6-pentadecene, cis-7-pentadecene, cis-8-pentadecene and cis-9-pentadecene as an acaricide. Preferably the alkene is cis-8-heptadecene.

In another aspect, the invention relates to a use of an alkene selected from the group consisting of cis-6-heptadecene, cis-7-heptadecene, cis-8-heptadecene, cis-9-heptadecene, cis-6-pentadecene, cis-7-pentadecene, cis-8-pentadecene and cis-9-pentadecene in the manufacture of a medicament for the prevention or treatment of mite infestation of bees. Preferably the alkene is cis-8-heptadecene.

In another aspect, the invention relates to a use of an alkene selected from the group consisting of cis-6-heptadecene, cis-7-heptadecene, cis-8-heptadecene, cis-9-heptadecene, cis-6-pentadecene, cis-7-pentadecene, cis-8-pentadecene and cis-9-pentadecene in the preparation of an acaricide. Preferably the alkene is cis-8-heptadecene.

In another aspect, the invention relates to a method of modulating mite infestation in a colony of bees comprising administering to said colony an effective amount of an alkene selected from the group consisting of cis-6-heptadecene, cis-7-heptadecene, cis-8-heptadecene, cis-9-heptadecene, cis-6-pentadecene, cis-7-pentadecene, cis-8-pentadecene and cis-9-pentadecene. Preferably the alkene is cis-8-heptadecene.

In another aspect, the invention relates to a method as described above, characterised in that said alkene is administered at a rate of not less than 1 μg/day.

In another aspect, the invention relates to a method as described above, characterised in that said alkene is administered for at least 20 days.

In another aspect, the invention relates to a method as described above, characterised in that said alkene is administered for at least two months.

### DETAILED DESCRIPTION OF THE INVENTION

This invention is essentially described and characterised in the principal claims. Other innovative characteristics of the invention are described in the secondary claims. This invention provides compositions that are specific and effective in controlling the reproduction of parasites in infested locations such as beehives, both larval and adult, so as to avoid damage caused by the parasites themselves such as reduced bee colony strength (family strength), the destruction of the colonies and reduced production of honey.

Another aspect of this invention is to use a chemical composition containing a substance active against parasites in beehives that is present at concentrations that do generate risks of toxic residues in the honey or wax.

The compositions and methods of the invention are useful in modulation of mite infestations such as acarid mite infestations. Modulation means reduction, prevention, inhibition, discouragement, disinfestation or other amelioration of mites in bee colonies.

Preferably the mites are acarid mites, preferably of the Varroidae family, preferably comprising Varroa destructor.

The active compound may be a single compound or a mixture of compounds, whether applied sequentially simultaneously or together.

The chemical composition, as per the invention, includes at least one alkene with a number of carbon atoms less than 23. This alkene is also an active compound and is, in particular, effective in the control of infestations in bee colonies by the Varroa destructor mite. The mite belongs to the family Varroidae, a family that also includes other related species.

This alkene, as per the invention, is non-toxic for bees at concentrations effective in the control of mites. Without wishing to be bound by theory, it is disclosed herein that it is a substance that is present on the bees themselves, presumably as a product of the decarboxylation of fatty acids, at least mono-unsaturates. This substance is produced, in particular, by a bee larva or pupa when it is parasitised, for example by the varroa, or in any case when it is injured or damaged, in a quantity in the order of thousand millionths of grams, and partially inhibits the reproduction of the parasite.

It is an advantage to use an alkene with an odd number of carbon atoms of between 15 and 23, and with at least one double bond in a position from 6 to 9 and in cis configuration. For the purpose of definition, carbon 6 or position 6 is intended to mean, for example, the sixth carbon atom from one end of the hydrocarbon chain; “double bond in position 6” is intended to mean the presence of a double bond between carbon 6 and carbon 7. As alkenes with a number of carbon atoms of less than 23 are produced in particular by the bee itself when it is injured or damaged by the parasite, it has a targeted and specific action against the parasite itself. This active compound reduces the reproduction rate of the parasite even when it is present in quantities in the order of 10 ng for each of the cells in which the bee completes its preimmaginal development.

The alkenes used in this invention may also include dienes with a number of carbon atoms of between 15 and 23 and with a double bond in a position from 6 to 9.

In a preferred solution, the chemical composition as per this invention would comprise heptadecene as active compound, with a double bond in position 8 in cis configuration (cis-8-C₁₇H₃₄); this active compound is able to reduce the number of eggs laid by the Varroa destructor during a reproductive cycle, with a dose that at least falls within the range 0.01-1 μg per bee cell.

According to another solution, the chemical composition as per this invention would contain heptadecene with a double bond in position 6 in cis configuration (cis-6-C₁₇H₃₄).

According to another solution, the chemical composition as per this invention would contain pentadecene with a double bond in position 7 in cis configuration (cis-7-C₁₅H₃₄).

Another advantage of this active compound as per this invention is that it is stable in mild conditions and substantially soluble in the most common organic solvents. Therefore the chemical composition may also include one or more excipients, thickening agents, antoxidants, or substances that attract the bees or provide nourishment for them, so as to facilitate the application of the active compound in the hive and in the cells in which the bees live.

Solvents include, for example, ketones, long-chain alcohols and their corresponding esters with long-chain fatty acids, and long-chain alkenes and alkanes, such as to modify the release rate of the active substances. The anti-oxidants include, for example BHT, 2,6-bis(1,1-dimethyl-ethyl)-4-methylphenol, ascorbic acid and similar substances.

Another purpose of this invention is to develop a method for the simple and effective distribution of the active compound that allows the regular and controlled release of that active compound over time in an infested location.

In accordance with this purpose, this invention also includes a method for the treatment of infestations of parasites that includes the application of a chemical composition based on at least one alkene with a number of carbon atoms less than 23. The control of infestations may be achieved by the application of the compositions as per this invention, for example in bee colonies, during the infestation. The active compound is particularly effective in reducing the number of offspring of the Varroa destructor mite, during the reproduction phase on the capped brood of the bees. Furthemore, the active compound prolongs the so-called phoretic phase, ie the phase in which the parasite is transported onto the adult bee. The active compound modifies the behavious of V. destructor, reducing its reproductive rate and increasing mortality. Application takes place using distribution systems designed to release the active compound, ensuring a regular release over a specified period of time and over a specified area. The distribution system is made up, for example, of at least one dispensing mechanism equipped with a sprayer, or a panel or surface fitted with a cavity to hold the composition to be distributed.

Other solutions for the distribution system involve one or more wax sheets, in which the chemical composition is embedded, or a polymer matrix into which the chemical composition is incorporated during the manufacturing process, or even at a later stage, or a hydrocarbon mass, impregnated with the chemical composition or into which the chemical composition is absorbed. The treatment for the control of infestations of parasites consists in application using distribution systems of these types in infested locations, such as inside the hives.

In addition, so as to be able to achieve an effective action, the distribution system must release, at each seat of infestation, a quantity of at least 100 ng/day of at least one active substance, preferably 10-100 or more μg/day.

The distribution system preferably incorporates 100 μg-10 mg of active compound. Preferably the treatment lasts for an interval of between 20 days and two months or more.

Another method for application of the chemical substance as per the invention involves the feeding of the bees directly with feed containing the active compound, for example using a syrup or other sugar-based feedstuff eaten by bees or by other animals or insects that are infested. The administration of the substance via feeding of the bees envisages a single application or repeat application for at least one month. If the administration is repeated, it would be advantageous to repeat it two to four times during the month of treatment.

The invention also relates to the following aspects:

A composition such as a chemical composition for the control of infestations by parasites, characterised by the fact that it comprises at least one alkene with a number of carbon atoms less than 23. Preferably this number of carbon atoms is not less than 15. Preferably the number of carbon atoms is odd. Preferably this alkene has at least one double bond in a position between 6 and 9. Preferably this alkene has only one double bond. Preferably this alkene is in cis configuration. Preferably this alkene has a double bond in a position corresponding to position 8.

When this alkene is a pentadecene, preferably it has a double bond in position 7 or 8 in cis configuration, preferably in position 7 in cis configuration.

When this alkene is a heptadecene, preferably it has a double bond in position 6, 7 or 8 in cis configuration, preferably it has a double bond in position 6 or 8 in cis configuration.

Most preferably this alkene is a heptadecene with a double bond in position 8 in cis configuration.

The alkene may be a diene, with at least one double bond in position 9.

Preferably the composition also contains one or more excipients.

Preferably the composition also contains one or more solvents.

Preferably the composition also contains one or more anti-oxidants.

The invention also relates to the use of a chemical composition as described above, characterised by the fact that this composition is used to disinfest bee colonies from parasites. Preferably these parasites belong to the family Varroidae.

The invention also relates to a method for the control of infestations of parasites, characterised by the fact that it comprises a phase involving distribution of a chemical composition based on at least one alkene with a number of carbon atoms less than 23. Preferably this distribution phase occurs via a distribution system designed to release this chemical composition. Preferably this distribution system comprises a wax, polymer or hydrocarbon-type panel, which is impregnated with this chemical composition. Preferably this distribution system comprises a spray device.

Preferably this distribution system is designed to distribute a quantity of this alkene not less than 1 μg/day. Preferably this distribution system contains a quantity of this alkene of between 10 μg and 10 mg. Preferably it lasts for a minimum of 20 days and up to two or more months.

When the infestation concerns a colony of bees, preferably this distribution system comprises sugar-based feed for the bees.

Other characteristics and advantages of the invention will become clear following a reading of some examples involving the chemical composition as per the invention and of some descriptions of methods for performance of the corresponding application processes.

### EXAMPLES OF PERFORMANCE

### Example 1

Inhibition of the Reproduction of V. destructor in Artificial Cells

In Example 1, a chemical composition is made up of a solution of heptadecene in hexane, with a double bond in position 8 and cis configuration (cis-8-C₁₇H₃₇). The cis-8-heptadecene in a solution of hexane causes a reduction in reproduction, ie a reduction in the number of offspring produced by the Varroa destructor mite, raised in a laboratory environment, on bee larvae in gelatine cells.

For verification of the activity of cis-8-C₁₇H₃₄, two groups of gelatine cells were prepared, with a diameter of 6.5 mm. In each of the two cells of the first group, 10 μg of hexane containing 100 ng of cis-8-heptadecene was deposited. This group was defined as the treated group. In the cells of the second group, 10 μg of hexane without active compound was deposited. This group was defined as the control group. The substances were deposited into each cell using a micropipette. The solvent was left to evaporate and then one varroa and one bee larva from natural, just-capped cells were introduced into each cell in each of the groups. The varroa was thus cultivated on the bee larva, during the metamorphosis of the larva, as happens in nature. Cultivation took place at 35° C. and 75% relative humidity. After ten days Oust before the bee reached its adult state), the cells were opened and inspected by microscope and the offspring produced by each varroa female were counted. The experiment described above was conducted four times; in total, approximately 80 cells were used per group.

Table 1 below indicates the mean numbers of offspring of V. destructor for each replication of the experiment.

TABLE 1
Mean number of offspring per varroa female in artificial cells
treated with cis-8-heptadecene as compared with control cells:
the treatment resulted in a reduction in the number of offspring
in the cells treated.

| | Number of offspring per | Number of offspring per |
|---|---|---|
| | varroa female in the | varroa female in the |
| Number of | artificial cells in the | artificial cells treated with |
| replications | control group | cis-8-heptadecene |
| 1 | 2.5 | 1.5 |
| 2 | 2.2 | 1.0 |
| 3 | 1.9 | 1.4 |
| 4 | 2.4 | 2.5 |
| Mean | 2.4 | 1.7 |

### Example 2

Inhibition of the Reproduction of V. destructor in Natural Cells

Example 2 was conducted in the same way as Example 1, except for the fact that the V. destructor mite was cultivated on bee larvae in natural cells from a beehive. In this example, too, the effect of 8-heptadecene on the reduction in the mean number of offspring produced by a female V. destructor in cells of natural honeycomb, kept in the hive, was verified.

For verification of the activity of cis-8-C₁₇H₃₄, two groups of natural cells were prepared. In the cells of the first group, referred to as the treated group, 1 μl of acetone containing 100 ng of cis-8-heptadecene was deposited. In the cells of the second group, the control group, 1 μl of the solvent alone, ie acetone, was deposited. The natural cells were cells just capped with honeycomb taken from infested hives and the product was deposited via injection of the solution using a microsyringe through the cell cap. Following treatment, the honeycomb was returned to the hive from which it was taken. After ten days, the honeycombs used for the experiment were brought to the laboratory; both the treated and control cells were opened and inspected. In the infested cells, the mean number of offspring produced by each varroa was counted. The experiment was replicated six times: in total, approximately 140 infested cells were examined for each group.

The mean number of offspring of each varroa in the cells in the group treated with cis-8-heptadecene was 3.2, while in the cells of the control group it was 3.8 (Table 2): the treatment therefore caused a reduction in the number of offspring in the treated cells.

TABLE 2
Number of offspring per varroa female in natural cells treated
with cis-8-heptadecene and in cells of the control group.

| | Number of offspring per | Number of offspring per |
|---|---|---|
| | varroa female in the | varroa female in the |
| Number of | natural cells in the control | natural cells treated with |
| replications | group | cis-8-heptadecene |
| 1 | 4.6 | 3.7 |
| 2 | 4.5 | 3.2 |
| 3 | 3.5 | 2.5 |
| 4 | 3.6 | 3.6 |
| 5 | 3.2 | 3.1 |
| 6 | 3.5 | 3.6 |
| Mean | 3.8 | 3.2 |

### Example 3

Inhibition of the Reproduction of V. destructor Via Dispensing of cis-8-heptadecene in Bee Colonies

In Example 3, ten nuclei were prepared, ie bee colonies with a reduced number of individuals, in the order of several thousand. Each nucleus was placed in a hive with dimensions smaller than those of a standard hive. These nuclei were divided into three groups—A and B, each with three nuclei, and C, with four nuclei.

Into each hive, a dispensing mechanism comprising a nylon grid, with a 100 μm mesh, square and with a side measurement of 10 cm, supported by a sheet of aluminium, was introduced. Solutions of cis-8-heptadecene in various concentrations in 100 μl of hexane were placed on each of these grids. The solvent was left to evaporate before each test. Group A was treated with 100 μg of cis-8-C₁₇H₃₄ in 100 μl of hexane, Group B with 10 μg of cis-8-C₁₇H₃₄ in 100 μg of hexane, and Group C with 100 μl of hexane without the addition of cis-8-C₁₇H₃₄ (control grou). The dispensing mchanism was changed in each hive each week; and treatment lasted for three weeks. At the end of the test, the number of V. destructor individuals present on the adult bees and in the brood cells was determined. The brood cells were removed from the hives, opened and inspected. Finally, the V. destructor individuals killed by the treatment were counted. The numbers of offspring of the V. destructor individuals present in the brood cells were calculated, separately for each developmental stage of the bees, and specifically pink-eyed pupae (pp), black-eyed pupae (pd) and pigmented pupae and adult bees (ppd). These tests revealed a reduction, albeit modest, given the limited quantity of product used, in the reproduction of V. destructor in the cells of the hives in Groups A and B, as from the black-eyed pupa stage (pd) (see Table 3).

TABLE 3
Number of offspring per female V. destructor inside
capped cells, in the control group and in the groups
treated in three brood stages

| | Number of | Number of | Number of |
|---|---|---|---|
| | offspring of | offspring of | offspring of |
| | V. destructor | V. destructor | V. destructor |
| | inside the | inside the | inside the |
| Developmental | capped cells | capped cells | capped cells |
| stage of | of Group A | of Group B | of Group C |
| the bees | (100 μg) | (10 μg) | (control) |
| PP: pink-eyed | 2 | 2 | 2 |
| pupae | | | |
| PD: black-eyed | 2.63 | 2.65 | 3.17 |
| pupae | | | |
| PDD [sic]: | 3.29 | 3.20 | 3.59 |
| pigmented | | | |
| pupae et | | | |
| adults | | | |

In the cells at brood stages more advanced than normal, the number of offspring was greater, as is to be expected given that the varroa had available a longer period of time for laying eggs (Table 3): from the pd stage, the number of offspring in the cells of the treated groups, A and 1, was lower than that of the offspring in Group C (control). Furthermore, in Group A, a greater proportion of varroa on adult bees was observed, ie in the phoretic phase (Table 4), which indicates a longer duration of this phase.

TABLE 4
Distribution of adult female V. destructor among the brood
cells (reproductive phase) and adult bees (phoretic phase)

| | Percentage | Percentage | Percentage |
|---|---|---|---|
| | distribution of | distribution of | distribution of |
| | V. destructor | V. destructor | V. destructor |
| | in Group | in Group | in Group |
| | A (100 μg) | B (10 μg) | C (control) |
| Varroa in the | 50 | 40 | 31 |
| phoretic phase | | | |
| Varroa in the | 50 | 60 | 69 |
| reproductive phase | | | |

### Example 5

Inhibition of the Reproduction of V. destructor in Artificial Cells Treated with cis-6-hetpadecene

Following the same procedure used in Example 1, a chemical composition made up of a solution of a heptadecene isomer as in Example 1, in this case the isomer with a double bond in position 6 (cis-6-C₁₇H₃₄), and a second composition containing a solution of cis-8-heptadecene (cis-8-C₁₇H₃₄) were applied. These compounds are also known as (Z)-6-C17:1 and (Z)-8-C17:1, indicating that these are mono-unsaturated compounds. Each test was replicated three times and the results are indicated in Table 5. Not just cis-8-heptadecene, the activity of which was demonstrated in Example 1, but also cis-6-heptadecene demonstrated inhibitory activity in respect of varroa reproduction.

TABLE 5
Number of offspring per varroa female in artificial cells treated
with the two isomers cis-6-C₁₇H₃₄ and cis-8-C₁₇H₃₄

| | | Number of | Number of |
|---|---|---|---|
| | Number of | offspring per | offspring per |
| | offspring per | varroa female in | varroa female in |
| | varroa female in | the artificial cells | the artificial cells |
| Number of | the artificial control | treated with cis-6- | treated with cis-8- |
| replications | cells | C₁₇H₃₄ | C₁₇H₃₄ |
| 1 | 2.6 | 2.4 | 2.0 |
| 2 | 2.3 | 2.3 | 1.5 |
| 3 | 3.2 | 1.7 | 2.0 |
| Mean | 2.6 | 2.1 | 1.9 |

It is therefore obvious that modifications and/or phase changes can be made to the chemical composition for the control of infestations of parasites and the corresponding method of application, without such modifications and changes departing from the scope of this invention.

It is also obvious that, while this invention has been described by reference to specific examples, an expert in the art could certainly develop other equivalent forms of the chemical composition for the treatment of infestations and the corresponding method of application, all within the scope of this invention.

1. A composition for the modulation of acarid infestation of a colony of bees, characterised in that the composition comprises (i) at least one alkene with an odd number of carbon atoms from 15 to 23, said alkene being in cis configuration and said alkene being selected from the group consisting of cis-6-heptadecene, cis-7-heptadecene, cis-8-heptadecene, cis-9-heptadecene, cis-6-pentadecene, cis-7-pentadecene, cis-8-pentadecene and cis-9-pentadecene; and (ii) at least one excipient, diluent or carrier.

2. A composition according to claim 1, characterised in that said alkene is a heptadecene with a double bond in position8 in cis configuration(cis-8-heptadecene).

3. A composition according to claim 1, characterised in that said alkene is a diene, with at least one double bond in position 9.

4. A composition according to claim 1, characterised in that it further comprises one or more solvent (s).

5. A composition according to claim 1, characterised in that it further comprises one or more antioxidants.

6. A method of controlling an acarid infestation, comprising contacting acarids in an acarid population with an acaricide composition of claim 1.

7. The method of claim 6 wherein said acarids belong to the family Varroidae.

8. The method of claim 7 wherein said acarids comprise Varroa destructor.

9. The method of claim 6 characterised in that the alkene or composition is administered by way of a distribution system comprising a wax, polymer or hydrocarbon-type panel which is impregnated with said alkene or composition, or a distribution system comprising a spray device, or a distribution system comprising sugar-based feed for bees.

10. The method of claim 9 characterised in that the distribution system initially contains a quantity of alkene of between 10 tug and 10 mg.

11. A method of controlling an acarid infestation, comprising contacting acarids in an acarid population with an acaricide composition comprising an alkene selected from the group consisting of cis-6-heptadecene, cis-7-heptadecene, cis-8-heptadecene, cis-9-heptadecene, cis-6-pentadecene, cis-7-pentadecene, cis-8-pentadecene and cis-9-pentadecene.

12. A method of claim 11 wherein the alkene is cis-8-heptadecene.

13. A method of preventing or treating a mite infection of bees, comprising contacting said bees with a compositions comprising an alkene selected from the group consisting of cis-6-heptadecene, cis-7-heptadecene, cis-8-heptadecene, cis-9-heptadecene, cis-6-pentadecene, cis-7-pentadecene, cis-8-pentadecene and cis-9-pentadecene.

14. A method of claim 13 wherein the alkene iscis-8-heptadecene.

15. A method of preparing an acaricide comprising preparing a formulation comprising an alkene selected from the group consisting of cis-6-heptadecene, cis-7-heptadecene, cis-8-heptadecene, cis-9-heptadecene, cis-6-pentadecene, cis-7-pentadecene, cis-8-pentadecene and cis-9-pentadecene in the preparation of an acaricide.

16. The method of claim 15 wherein the alkene is cis-8-heptadecene.

17. A method of modulating mite infestation in a colony of bees comprising administering to said colony an effective amount of an alkene selected from the group consisting of cis-6-heptadecene, cis-7-heptadecene, cis-8-heptadecene, cis-9-heptadecene, cis-6-pentadecene, cis-7-pentadecene, cis-8-pentadecene and cis-9-pentadecene.

18. A method according to claim 17 wherein the alkene is cis-8-heptadecene.

19. A method according to claim 17, characterised in that said alkene is administered at a rate of not less than 1 ug/day.

20. A method according to claims 17, characterised in that said alkene is administered for at least 20 days.

21. A method according to claim 20, characterised in that said alkene is administered for at least two months.

22. A composition, use or method substantially as described herein.

23. A composition according to claim 2, characterised in that said alkene is a diene, with at least one double bond in position 9.

24. A composition according to claim 2, characterised in that it further comprises one or more solvent (s).

25. A composition according to claim 3, characterised in that it further comprises one or more solvent (s).

26. A composition according to claim 2, characterised in that it further comprises one or more antioxidants.

27. A composition according to claim 3, characterised in that it further comprises one or more antioxidants.

28. A composition according to claim 4, characterised in that it further comprises one or more antioxidants.

29. A method of controlling an acarid infestation, comprising contacting acarids in an acarid population with an acaricide composition of claim 2.

30. A method of controlling an acarid infestation, comprising contacting acarids in an acarid population with an acaricide composition of claim 3.

31. A method of controlling an acarid infestation, comprising contacting acarids in an acarid population with an acaricide composition of claim 4.

32. A method of controlling an acarid infestation, comprising contacting acarids in an acarid population with an acaricide composition of claim 5.

33. The method of claim 7 characterised in that the alkene or composition is administered by way of a distribution system comprising a wax, polymer or hydrocarbon-type panel which is impregnated with said alkene or composition, or a distribution system comprising a spray device, or a distribution system comprising sugar-based feed for bees.

34. The method of claim 8 characterised in that the alkene or composition is administered by way of a distribution system comprising a wax, polymer or hydrocarbon-type panel which is impregnated with said alkene or composition, or a distribution system comprising a spray device, or a distribution system comprising sugar-based feed for bees.

35. A method according to claim 18, characterised in that said alkene is administered at a rate of not less than 1 ug/day.

36. A method according to claim 18, characterised in that said alkene is administered for at least 20 days.

37. A method according to claim 19, characterised in that said alkene is administered for at least 20 days.
